(19) United States
(12) Patent Application Publication
(10) Pub. No.: US 2026/0371431 A1
(43) Pub. Date: Nov. 19, 2026

(54) Mobile Originating Call Redirection and Restoration

(71) Applicant: T-Mobile Innovations LLC, Overland Park, KS (US)

(72) Inventors: Khurram MIRZA, Renton, WA (US); Madhuri KOTTA, Bellevue, WA (US)

(21) Appl. No.: 19/208,843

(22) Filed: May 15, 2025

(51) Int. Cl. H04W 76/19; H04L 65/1016; H04L 65/1104

(52) U.S. Cl. CPC H04W 76/19; H04L 65/1016; H04L 65/1104

(57) ABSTRACT

Methods and systems provided herein provide for restoring a SIP invite that has been redirected by a wireless device from a first P-CSCF to a disaster recovery P-CSCF of an Internet Protocol (IP) multimedia subsystem (IMS) core function. At an IP IMS core function, the path of data transmission is adjusted for the wireless device from the first P-CSCF to the disaster recovery P-CSCF.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G new radio (NR) and millimeter wave (mm-wave) networks, as well as 4G long-term evolution (LTE) access nodes and older legacy protocols.

During the evolution of newer wireless RATs, improved voice services have become available. For example, with 4G networks, Voice over Long-Term Evolution (VoLTE), which is an LTE high speed wireless communication standard for voice calls became available. Further, with the development of 5G networks, Voice over New Radio (VoNR), which fully utilizes the 5G standalone (SA) core network was developed. In either case, to support VoLTE or VoNR, a network must be a Voice over Packet Switched (VoPS) network utilizing an Internet Protocol (IP) Multimedia Subsystem (IMS).

The IMS includes a call session control function (CSCF) with multiple components including a proxy call session control function (P-CSCF) that functions as an entry point for IMS traffic from user equipment (UEs) or wireless devices. The P-CSCF forwards requests to IMS core functions.

### Overview

Exemplary embodiments provided herein include a method, system, processing node, and/or non-transitory computer-readable medium for mobile originating call redirection and restoration. In one exemplary embodiment, a method is provided. The method includes receiving a response to a session initiation protocol (SIP) invite from a first proxy call session control function (P-CSCF) of an Internet Protocol (IP) multimedia subsystem (IMS) core function. The response indicates that the SIP invite to the first P-CSCF has failed. The SIP invite is redirected to a disaster recovery (second) P-CSCF of the IP IMS core function. The disaster recovery P-CSCF is a different P-CSCF from the first P-CSCF.

Exemplary embodiments provided herein include a method, system, processing node, and/or non-transitory computer-readable medium for mobile originating call redirection and restoration. In one exemplary embodiment, a method is provided. The method includes receiving a SIP invite from a wireless device that has been redirected by a wireless device from a first P-CSCF to a disaster recovery P-CSCF of an Internet Protocol (IP) multimedia subsystem (IMS) core function. The method further includes, adjusting, at an interrogating call session control function (I-CSCF) of the IP IMS core function, the path of data transmission for the wireless device from the first P-CSCF to the disaster recovery P-CSCF.

In some embodiments, the method further includes directing the SIP invite to a serving call session control function (S-CSCF) of the IP IMS core function. The method further includes adjusting, at the IP IMS core function, the path of data transmission for the wireless device from the first P-CSCF to the disaster recovery P-CSCF.

In further exemplary embodiments a system is provided including a memory storing data and instructions and a processor executing the stored instructions to perform multiple operations. The operations include receiving a SIP invite from a wireless device that has been redirected by a wireless device from a first P-CSCF to a disaster recovery P-CSCF of an Internet Protocol (IP) multimedia subsystem (IMS) core function. The operations further include, adjusting, at an interrogating call session control function (I-CSCF) of the IP IMS core function, the path of data transmission for the wireless device from the first P-CSCF to the disaster recovery P-CSCF.

In further embodiments, non-transitory computer-readable mediums or processing nodes store instructions executed by a processor to perform the operations described herein.

### BRIEF DESCRIPTION OF THE DRAWINGS

FIG. 1 depicts an exemplary communication network that implements a mobile originating call redirection and restoration system in accordance with an embodiment.

FIG. 2 depicts mobile originating call redirection and restoration in accordance with an embodiment.

FIG. 3 depicts a method for performing mobile call restoration in accordance with an embodiment.

FIG. 4 depicts a further exemplary method for performing mobile call restoration in accordance with an embodiment.

FIG. 5 depicts a mobile originating call restoration system in accordance with an embodiment.

### DETAILED DESCRIPTION

To initiate a call, a mobile originating (MO) wireless device sends a SIP invite via the IMS core to a mobile terminating (MT) wireless device. The SIP invite is transmitted to a proxy call session control function (P-CSCF) that functions as an entry point for IMS traffic from wireless devices.

IMS core components may experience an internal error or other circumstance in which they are unable to provide a normal call flow after receiving the SIP invite. A first P-CSCF may be unable to process a VoLTE or VoNR call due to internal issues or issues with other components, such as the S-CSCF. The first P-CSCF sends a response to the MO wireless device indicating failure of the SIP invite. Currently, the SIP invite is terminated after receiving a failure notification from the first P-CSCF. After the SIP invite is terminated, the wireless device has to start over. The MO wireless device has to initiate a new call by generating a new SIP invite and attempting to connect to the P-CSCF. The MO wireless device may continue to send new SIP invites to the P-CSCF that is unable to process the call continuing to delay the call and use resources of the wireless device and the network.

Accordingly, embodiments are provided herein for redirecting the SIP invite to a disaster recovery P-CSCF and performing call restoration at the IMS core instead of terminating the SIP invite. The disaster recovery P-CSCF is identified from a list of P-CSCFs stored in in the protocol configuration options (PCO) of the wireless device. The disaster recovery P-CSCF performs restoration with IMS core and the call is completed.

Accordingly, embodiments provided herein include MO wireless device call redirection and restoration. The MO wireless device receives a response to a SIP invite from a first P-CSCF of the IMS core. The response indicates that the SIP invite to the first P-CSCF has failed. The MO wireless device redirects the SIP invite to a disaster recovery P-CSCF of the IP IMS core.

The disaster recovery P-CSCF receives the redirected SIP invite from the MO wireless device that has been redirected by a wireless device from the first P-CSCF to the disaster recovery P-CSCF. In embodiments, the MO wireless device is instructed to register with the disaster recovery P-CSCF of the IMS core. The disaster recovery P-CSCF sends the SIP invite to the IMS core.

Embodiments of the MO wireless device call redirection and restoration system provided herein facilitate successful SIP invites and calls. Providing redirection of the SIP invite can restore a call currently being processed and will prevent additional failures from occurring. In order to implement the solution, the SIP invite is redirected by the MO wireless device from a first P-CSCF to a disaster recovery P-CSCF. In embodiments, the network core adjusts the path of data transmission for the SIP invite redirected by the MO wireless device from the first P-CSCF to the disaster recovery P-CSCF. Upon adjustment, the redirected SIP invite is successful and the MO wireless device call is connected to the MT wireless device. The MO wireless device now does not need to send a new SIP invite to the P-CSCF causing delay and needless use of network resources.

In addition to the systems and methods described herein, non-transitory computer-readable mediums may store the operations for the instructions or methods. Further, processing nodes on the network may execute the instructions or methods.

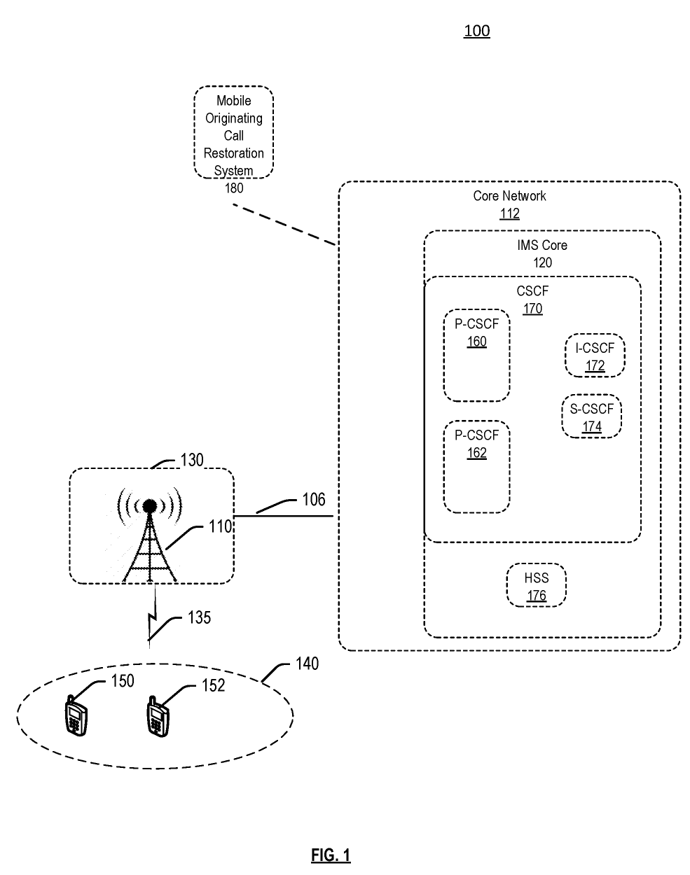

FIG. 1 depicts an exemplary communication network 100 that implements a MO call redirection and restoration system. Communication network 100 comprises a communication network 100. The communication network 100 comprises a core network 112 and a radio access network (RAN) 130, in which RAN 130 includes at least an access node 110. Wireless devices 150 and 152 are located in a coverage area 140 provided by the access node 110 and communicate with the access node 110 over one or more communication links, such as a communication link 135. Although only two wireless devices 150, 152 are shown, it should be understood that any number of wireless devices could be included. Further, an IP multimedia subsystem (IMS) core 120 is part of core network 112. The IMS core 120 includes a call session control function (CSCF) 170 including a first proxy call session control function (P-CSCF) 160 and a disaster recovery P-CSCF 162, an interrogating call session control function (I-CSCF) 172, and a serving call session control function (S-CSCF) 174. While both the core network 112 and the IMS core 120 include additional features, these features are omitted for the purposes of explanation and simplification.

Further, MO call redirection and restoration system 180 interacts with the IMS core 120 to operate based on requests received from wireless devices 150, 152 at first P-CSCF 160 and disaster recovery P-CSCF 162. The first P-CSCF 160 and disaster recovery P-CSCF162 further interact with the IMS core 120. The MO call redirection and restoration system 180 is illustrated as communicating with or incorporated in the first P-CSCF 160, disaster recovery P-CSCF 162 and/or the IMS core 120. Wireless device 150 may be the MO wireless device while wireless device 152 may be the MT wireless device 152.

In operation, the wireless device 150 sends a SIP invite over wireless communication link 135 to an access node 110 of the RAN 130. The SIP invite ultimately reaches the first P-CSCF 160 or disaster recovery P-CSCF 162. In response to the SIP invite, the first P-CSCF 160 and/or disaster recovery P-CSCF 162 may communicate with the IMS core 120 to try to establish a session with another wireless device, such as the wireless device 152.

The first P-CSCF 160 or disaster recovery P-CSCF 162 acts as the ingress and egress point to and from the IMS core 120. Requests originating from wireless device 150 pass through a P-CSCF before wireless device 150 can access the services of the IMS core 120. The first P-CSCF 160 and/or disaster recovery P-CSCF 162 may interact with the IMS core 120.

The first P-CSCF 160 or disaster recovery P-CSCF 162, when operational, is responsible for onward routing of registration and session requests to the correct nodes in the network, ensuring the S-CSCF 174 is kept updated on the access network 130 providing session information to the core network 112 and maintaining a secure connection with the wireless devices 150 and 152. The first P-CSCF 160 or disaster recovery P-CSCF162 can inspect all signals and provide authentication. The I-CSCF 172 retrieves the address of the S-CSCF 174 and assigns it to a wireless device performing SIP registration. The I-CSCF 172 also forwards the SIP request or response to the S-CSCF 174. The S-CSCF 174 is a SIP server that performs session control and handles SIP registrations. The S-CSCF 174 decides to which application server the SIP message will be forwarded, in order to provide their services.

The RAN 130 can include various access network functions and devices disposed between the core network 112 and the wireless devices 150, 152. For example, the RAN 130 includes at least an access node (or base station), such as an eNodeB and/or a next generation NodeB (gNodeB) 110 communicating with the wireless devices 150, 152. Further, either of core network 112 and RAN 130 can include one or more of a local area network, a wide area network, and an internetwork (including the Internet) and be capable of communicating signals and carrying data, for example, to support voice, push-to-talk, broadcast video, and data communications by the wireless devices 150, 152.

Access node 110 can be any network node configured to provide communication between the wireless devices 150 and 152 and communication network 100, including standard access nodes and/or short range, low power, small access nodes. For instance, access node 110 may include any standard access node, such as a macrocell access node, base transceiver station, or a radio base station, or the like. In embodiments further discussed herein, the access node 110 is an eNB or gNB. However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 150, 152 are illustrated in FIG. 1, any number of access nodes 110 and wireless devices 150, 152 can be implemented within communication network 100.

As further described herein, by utilizing antennas, access node 110 can deploy a communication link 135 using one or more frequency bands over one or more coverage areas 140. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless devices 150, 152 may be any device, system, combination of devices, or other such communication platform capable of communicating wirelessly with access node 110 using one or more frequency bands deployed therefrom. Wireless devices 150, 152 may be, for example, a mobile phone, a wireless phone, a wireless modem, a personal digital assistant (PDA), a voice over internet protocol (VoIP) phone, a voice over packet (VOP) phone, a soft phone as well as other types of devices or systems that can exchange audio or data via access node 110. The wireless devices 150, 152 can be end-user wireless devices (e.g., user equipment (UEs)) utilizing communication links 135, which may operate based on 6G, 5G new radio (NR), 4G long term evolution (LTE), or any other suitable type of ratio access technology (RAT).

The core network 112 may include a service based architecture (SBA) architecture, in which service-based interfaces may be utilized between control plane functions, while multiple user plane functions connect over point-to-point link. Each network function may expose its functionality through a Service-Based Interface (SBI). The core network 112 may alternatively or additionally have an evolved packet core (EPC) structure.

Communication links between various components of the communication network 100, such as communication link 106, can use various communication media, such as air, space, metal, optical fiber, or some other signal propagation path - including combinations thereof. Communication links can be wired or wireless and use various communication protocols such as Internet, Internet protocol (IP), local-area network (LAN), optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol as described herein. Communication links can be a direct link or might include various equipment, intermediate components, systems, and networks. Communication links may comprise many different signals sharing the same link.

Communication network 100 can be a wired and/or wireless communication network, and can comprise processing nodes, routers, gateways, physical and/or wireless data links for carrying data among various network elements, including combinations thereof, and can include a local area network, a wide area network, and an internetwork (including the Internet). Communication network 100 can be capable of carrying data, for example, to support voice, push-to-talk, broadcast video, and data communications by wireless devices. Wireless network protocols can comprise MBMS, code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), Fifth Generation mobile networks or wireless systems (5G, 5G New Radio (“5G NR”), or 5G LTE), and/or other wireless network protocols. Wired network protocols that may be utilized by communication network 100 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM), and/or other wired network protocols. Communication network 100 can also comprise additional base stations, controller nodes, telephony switches, internet routers, network gateways, computer systems, communication links, or some other type of communication equipment, and combinations thereof.

Other network elements may be present in communication network 100 to facilitate communication but are omitted for clarity, such, base station controllers, mobile switching centers, dispatch application processors, network functions, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 100.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication network 100 may be, comprise, or include computers systems and/or processing nodes.

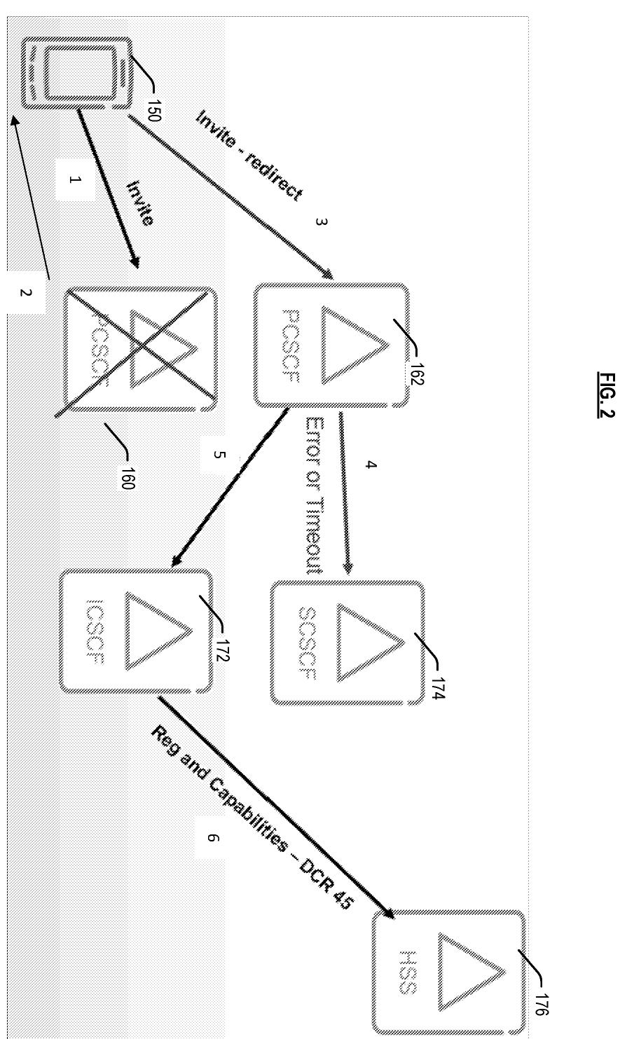

FIG. 2 depicts a process of mobile originating call redirection and restoration in accordance with an embodiment. At step 1, wireless device 150 sends a SIP invite to a first P-CSCF 160. At step 2, wireless device 150 receives a response to the SIP invite from first P-CSCF 160 of the IMS core. The response indicates that the SIP invite to the first P-CSCF 160 has failed. At step 3, wireless device 150 redirects the SIP invite to a disaster recovery P-CSCF 162 of the IP IMS core. In embodiments, the wireless device 150 is instructed to register with the disaster recovery P-CSCF 162 of the IMS core. The disaster recovery P-CSCF 162 ends the SIP invite to the IMS core.

The disaster recovery P-CSCF 162 receives the redirected SIP invite from wireless device 150 that has been redirected by the wireless device 150 from the first P-CSCF 160 to the disaster recovery P-CSCF 162 of the IMS core. At step 4, the disaster recovery P-CSCF 162 directs the SIP invite to the S-CSCF 174 of the IMS core. As the SIP invite was initially set up the first P-CSCF 160, the S-CSCF 174 may return an error response or timeout notification to the disaster recovery P-CSCF 162. Responsive to receiving the error response or timeout notification from the S-CSCF 174, the disaster recovery P-CSCF 162 communicates with the I-CSCF 172 at step 5. The I-CSCF 172 adjust the path of data transmission for SIP invite from the first P-CSCF 160 to the disaster recovery P-CSCF 162. At step 6, the I-CSCF 172 sends the regulations and capabilities to the HSS 176 including the adjusted path of data transmission using the disaster recovery P-CSCF 162 rather than the first P-CSCF 160. With the adjusted path of data transmission, the redirected SIP invite is successful and wireless device 150 call is connected to a MT wireless device using the adjusted path of data transmission via the disaster recovery P-CSCF 162.

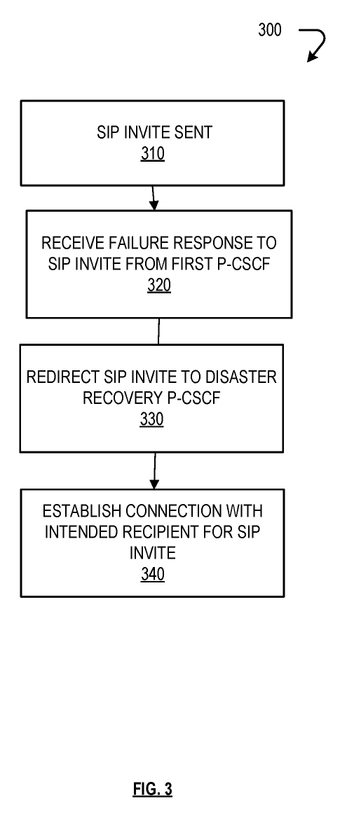

FIG. 3 illustrates a generalized exemplary method 300 for operating a MO call redirection and restoration systemin accordance with embodiments provided herein. Various steps of method 300 may be performed by a processor of a wireless device, such as wireless device 150. Additionally, some steps of the method 300 are performed by other components, such as one or more processors of the MO call redirection and restoration system 180, the first P-CSCF 160 and/or the disaster recovery P-CSCF 162.

Method 300 starts in step 310, in which a SIP invite is sent from a first wireless device 150 to a first P-CSCF 160 in a wireless network. Upon transmission of the SIP invite, the first P-CSCF 160 attempts to establish a connection between the first wireless device 150 via the IMS core to a disaster recovery wireless device 152.

In step 320, a failure response to the SIP invite is received from the first P-CSCF 160 at wireless device 150. IMS core components, such as the first P-CSCF 160 or S-CSCF 174 may experience an internal error or other circumstance in which they are unable to provide a normal call flow after receiving the SIP invite. The first P-CSCF 160 may be unable to process a VoLTE or VoNR call due to internal issues or issues with other components, such as the S-CSCF 174.

In step 330, the wireless device 150 redirects the SIP invite to a disaster recovery P-CSCF 162. A disaster recovery P-CSCF 162 is identified from a list of P-CSCFs stored in in the protocol configuration options (PCO) of wireless device 150. Wireless device 150 is instructed to register with the disaster recovery P-CSCF 162 of the IMS core. The disaster recovery P-CSCF sends the SIP invite to the IMS core and performs restoration with IMS core. In step 340, wireless device 150 establishes a connection with wireless device 152 using disaster recovery P-CSCF 162.

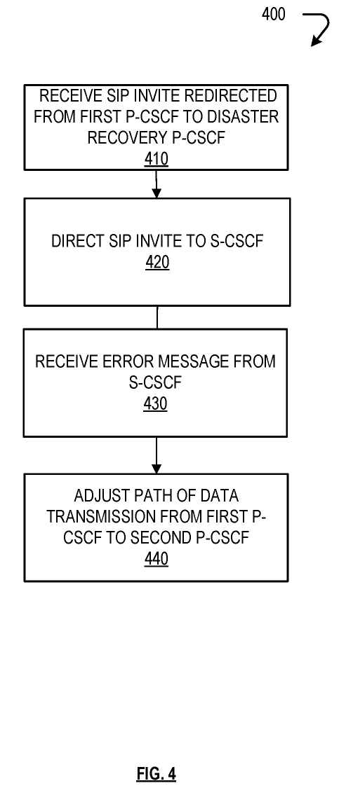

FIG. 4 depicts a further exemplary method 400 for MO wireless device call restoration in accordance with embodiments disclosed herein. For discussion purposes, as an example, method 400 is described as being performed by the processor 510 included in the MO call redirection and restoration system 180, which may be wholly or partially incorporated in the first P-CSCF 160 and/or disaster recovery P-CSCF 162.

Method 400 starts in step 410, in which the processor 510 receives the SIP invite from wireless device 150 that has been redirected from the first P-CSCF 160 to the disaster recovery P-CSCF 162. In one example, in step 420 the disaster recovery P-CSCF 162 directs the SIP invite to the S-CSCF 174. In step 430, an error response or timeout notification is received from the S-CSCF 174. The error response of timeout notification may occur as the first P-CSCF 160 has already attempted to establish a connection for the redirected SIP invite. Thus, in step 440, responsive to receiving the error response or timeout notification from the S-CSCF 174, the I-CSCF 172 adjusts the path of data transmission for SIP invite redirected by the MO wireless device 150 from the first P-CSCF 160 to the disaster recovery P-CSCF 162. Based on the adjusted path of data transmission wireless device 150 establishes a connection with wireless device 152 using disaster recovery P-CSCF 162.

Accordingly, as set forth above, embodiments providing for transaction awareness timing are disclosed. In some embodiments, methods 300 and 400 may include additional steps or operations and additional network components. Furthermore, the methods may include steps shown in each of the other methods. Additionally, the order of steps shown is merely exemplary and the steps may be re-ordered as appropriate. As one of ordinary skill in the art would understand, the methods 300 and 400 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

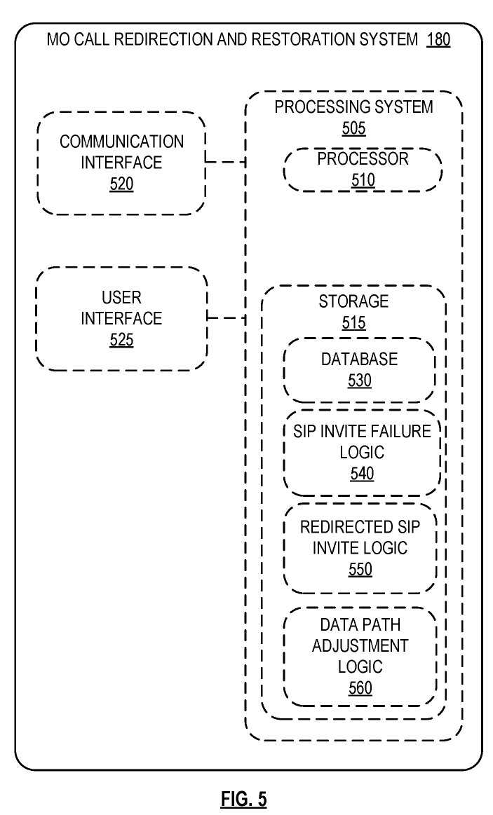

FIG. 5 illustrates a MO wireless device redirection and restoration system 180 in accordance with embodiments described herein. The components described herein are merely exemplary as many different configurations for the MO wireless device redirection and restoration system 180 may be implemented. The MO wireless device redirection and restoration 500 may be configured to perform the methods and operations disclosed herein to dynamically redirect failed SIP-invites from the first P-CSCF 160 to the disaster recovery P-CSCF 162 and restore the call set up for the SIP invite at the IMS core.

As illustrated in FIG. 5, The MO wireless device redirection and restoration system 180 may be configured for performing the operations described herein utilizing a processing system 505. Processing system 505 may include a processor 510 and a storage device 515. Storage device 515 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 510 to perform various methods disclosed herein. Software stored in storage device 515 may include computer programs, firmware, or other form of machine-readable instructions, including an operating system, utilities, drivers, network interfaces, applications, or other type of software. For example, software stored in storage device 515 may include a module for performing various operations described herein.

SIP failure logic 540 may allow for determination that a SIP invite from a wireless device to a first P-CSCF has failed and further may interact with redirected SIP invite logic 550. The redirected SIP invite logic 550 may redirect the SIP invite from the first P-CSCF to a disaster recovery P-CSF in the IMS core. SIP invite logic 550 may interact with data path adjustment logic 560. Data path adjustment logic 560 adjust the data path for the SIP invite from the first P-CSCF to a disaster recovery P-CSCF so that a connection is made. Further, the storage device 515 may include a database 530. To perform the above-described operations, the SIP failure logic 540, the redirected SIP invite logic 550 and the data path adjustment logic 560 may be executed by the processor 510 to proactively manage failure of the first P-CSCF or other IMS core components.

Processor 510 may be a microprocessor and may include hardware circuitry and/or embedded codes configured to retrieve and execute software stored in storage device 515. The system 180 further includes a communication interface 520 and a user interface 525. Communication interface 520 may be configured to enable the processing system 505 to communicate with other components, nodes, or devices in the wireless network.

Communication interface 520 may include hardware components, such as network communication ports, devices, routers, wires, antenna, transceivers, etc. User interface 525 may be configured to allow a user to provide input to the MO call redirection and restoration system 180 and receive data or information from other system components. User interface 525 may include hardware components, such as touch screens, buttons, displays, speakers, etc. The MO call redirection and restoration system 180 may further include other components such as a power management unit, a control interface unit, etc. The location of the MO call redirection and restoration system 200 may depend upon the network architecture. As set forth above, the MO call redirection and restoration system 180 may be located in a separate processing node, in the P-CSCF 160, or elsewhere in the IMS core120. Further, although shown as a single integrated system, the functions of the MO call redirection and restoration system may be separated and be disposed in separate locations.

Thus, the MO wireless device redirection and restoration system 180 may interact with the first P-CSCF 160 and disaster recovery P-CSCF 162 of the IMS core 120 to ensure SIP invites are redirected in a timely manner from the first P-CSCF 160 to the disaster recovery P-CSCF 162. In the disclosed embodiments, MO wireless device redirection and restoration system 180 may be integrated with the first P-CSCF 160, disaster recovery P-CSCF 162 or may be an entirely separate component capable of communicating with the first P-CSCF 160, disaster recovery P-CSCF 162 and wireless device 150. Further, the components of the MO wireless device redirection and restoration system 180 may be distributed so that one or more components are located within the first P-CSCF 160, disaster recovery P-CSCF 162, wireless device 150 and/or a separate processing node in communication with or integrated with the first P-CSCF 160, disaster recovery P-CSCF 162, and wireless device 150.

he above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
receiving a response from a first proxy call session control function (P-CSCF) of an Internet Protocol (IP) multimedia subsystem (IMS) core function at a wireless device to a session initiation protocol (SIP) invite, the response indicating that the SIP invite to the first P-CSCF has failed; and
redirecting the SIP invite to a disaster recovery P-CSCF of the IP IMS core function.

2. The method of claim 1, wherein the wireless device is a mobile originating (MO) wireless device.

3. The method of claim 2, wherein the disaster recovery P-CSCF is identified from a list of P-CSCFs stored in protocol configuration options (PCO) of the wireless device.

4. The method of claim 3, wherein the SIP invite is to connect with a mobile terminating (MT) device.

5. The method of claim 4, wherein the MO device is connected to the MT device using the disaster recovery P-CSCF of the IP IMS core function.

6. The method of claim 5, wherein a path of data transmission from the MO device to the MT device uses the disaster recovery P-CSCF.

7. A non-transitory computer-readable medium storing instructions executed by processor to perform operations comprising:
receiving a response from a first proxy call session control function (P-CSCF) of an Internet Protocol (IP) multimedia subsystem (IMS) core function at a wireless device to a session initiation protocol (SIP) invite, the response indicating that the SIP invite to the first P-CSCF has failed; and
redirecting the SIP invite to a disaster recovery P-CSCF of the IP IMS core function.

8. The non-transitory computer-readable medium of claim 7, wherein the wireless device is a mobile originating (MO) wireless device.

9. The non-transitory computer-readable medium of claim 8, wherein the disaster recovery P-CSCF is identified from a list of P-CSCFs stored in protocol configuration options (PCO) of the wireless device.

10. The non-transitory computer-readable medium of claim 9, wherein the SIP invite is to connect with a mobile terminating (MT) device.

11. The non-transitory computer-readable medium of claim 7, wherein the MO device is connected to the MT device using the disaster recovery P-CSCF of the IP IMS core function.

12. The non-transitory computer-readable medium of claim 7, wherein a path of data transmission from the MO device to the MT device uses the disaster recovery P-CSCF.

13. The non-transitory computer-readable medium of claim 7, wherein the first P-CSCF is different from the disaster recovery P-CSCF.

14. A system comprising:
a memory storing data and instructions;
a processor executing the stored instructions to perform operations including:
receiving a response from a first proxy call session control function (P-CSCF) of an Internet Protocol (IP) multimedia subsystem (IMS) core function at a wireless device to a session initiation protocol (SIP) invite, the response indicating that the SIP invite to the first P-CSCF has failed; and
redirecting the SIP invite to a disaster recovery P-CSCF of the IP IMS core function.

15. The system of claim 14, wherein the wireless device is a mobile originating (MO) wireless device.

16. The system of claim 15, wherein the disaster recovery P-CSCF is identified from a list of P-CSCFs stored in protocol configuration options (PCO) of the wireless device.

17. The system of claim 16, wherein the SIP invite is to connect with a mobile terminating (MT) device.

18. The system of claim 17, wherein the MO device is connected to the MT device using the disaster recovery P-CSCF of the IP IMS core function.

19. The system of claim 18, wherein a path of data transmission from the MO device to the MT device uses the disaster recovery P-CSCF.

20. The system of claim 14, wherein the first P-CSCF is different from the disaster recovery P-CSCF.
